(19) United States
(12) Patent Application Publication
(10) Pub. No.: US 2025/0055047 A1
(43) Pub. Date: Feb. 13, 2025

(54) ACTIVE CELL VENT CONTROL

(71) Applicant: Our Next Energy, Inc., Novi, MI (US)

(72) Inventor: Nathan Saliga, Clarkston, MI (US)

(73) Assignee: Our Next Energy, Inc., Novi, MI (US)

(21) Appl. No.: 18/799,365

(22) Filed: Aug. 9, 2024

Related U.S. Application Data
(60) Provisional application No. 63/518,654, filed on Aug. 10, 2023.

(51) Int. Cl. H01M 10/42; B60L 58/10; H01M 50/35

(52) U.S. Cl. CPC H01M 10/425; B60L 58/10; H01M 50/35; H01M 2220/20

(57) ABSTRACT

Actively venting by measuring venting parameters of the cell, computing, using the venting parameters, a pre-venting state of the cell, and preemptively triggering, responsive to computing that the pre-venting state has reached a threshold pre-venting state, an opening of a vent of the cell to release vent-gas. The preemptive triggering is performed by activating a cell vent opening device to open the vent.

### BACKGROUND

### Technical Field

The present disclosure generally relates to active cell vent control and more particularly to electronically and preemptively venting a cell prior to a failure event of the cell.

### Description of the Related Art

Battery cells have been used in a wide array of applications including electric vehicles and energy storage systems to provide a source of energy. The battery cells charge and discharge by moving metal ions between a positive electrode and a negative electrode. A typical battery may need protection from harsh external conditions and battery enclosures may be designed to provide such protection. However, the battery may also undergo internal temperature and pressure changes that may lead to problems without proper management. Considering these, proper design and battery management are crucial to optimal battery performance.

### BRIEF SUMMARY

According to an embodiment of the present disclosure, a method is disclosed. The method includes actively venting by measuring venting parameters of the cell, computing, using the venting parameters, a pre-venting state of the cell, and preemptively triggering, responsive to computing that the pre-venting state has reached a threshold pre-venting state, an opening of a vent of the cell to release vent-gas. The preemptive triggering may be performed by activating a cell vent opening device to open the vent.

In as aspect herein, the method may be performed by a trained machine learning model, by combinatorial analyses, by threshold venting parameter determination or a combination thereof.

According to an embodiment of the present disclosure, a system is disclosed. The system includes a cell, a cell vent opening device, processor, and a memory storing instructions that, when executed by the processor, configure the system to measure one or more venting parameters of the cell, compute, using the one or more venting parameters, a pre-venting state of the cell, and preemptively trigger, responsive to computing that the pre-venting state has reached a threshold pre-venting state, an opening of a vent of the cell to release vent-gas.

According to an embodiment of the present disclosure, a non-transitory computer-readable medium is disclosed. The non-transitory computer-readable medium may store instructions that when executed by a computer, cause the computer to measure one or more venting parameters of the cell, compute, using the one or more venting parameters, a pre-venting state of the cell, and preemptively trigger, responsive to computing that the pre-venting state has reached a threshold pre-venting state, an opening of a vent of the cell to release vent-gas.

### BRIEF DESCRIPTION OF THE DRAWINGS

To easily identify the discussion of any particular element or act, the most significant digit or digits in a reference number refer to the figure number in which that element is first introduced.

FIG. 1 depicts a block diagram of a power supply environment including a network of data processing systems in accordance with an illustrative embodiment.

FIG. 2 depicts a block diagram of a data processing system in accordance with an illustrative embodiment.

FIG. 3 depicts a block diagram of a power supply system in accordance with an illustrative embodiment.

FIG. 4 depicts a perspective view of a cell in accordance with an illustrative embodiment.

FIG. 5 depicts a routine in accordance with an illustrative embodiment.

FIG. 6 depicts a block diagram illustrating a training system in accordance with an illustrative embodiment.

### DETAILED DESCRIPTION

The illustrative embodiments are directed to electronically venting a cell prior to the cell reaching a mechanical vent pressure. The illustrative embodiments recognize that venting in EV (electric vehicle) and other battery systems may be performed to the release or expel gases or fumes from a cell or battery pack. Battery systems typically comprise Lithium-Ion and/or other chemistries, which may generate heat and potentially produce gases under certain conditions. The illustrative embodiments recognize that venting mechanisms may be designed to release these gases to maintain the safety and integrity of the battery system. This may help be instrumental for thermal management and safety. During normal operation and charging, a cell in a battery pack may generate heat. When the temperature inside the battery pack rises too high, heat produced may cause the cell to release gases. Vents of the cell may then rupture to allow for the release of these gases to mitigate a buildup of pressure inside the battery pack, which could potentially lead to a battery failure or even a thermal runaway event. In the event of an abnormal condition or failure event, such as a short circuit or physical damage to the battery cells, venting may release these gases to mitigate the risk of a sudden explosion and further damage. However, the illustrative embodiments recognize that in such situations, it is typically too late to prevent destruction of the cell due to the passive nature of the vent rupture.

The illustrative embodiments recognize that by monitoring cell health in a battery pack, the failure of a cell may be predicted, and a cell vent thereof may be actively controlled to release pressure buildup to aid in preemptive thermal management and safety of the battery system.

Certain operations are described as occurring at a certain component or location in an embodiment. Such locality of operations is not intended to be limiting on the illustrative embodiments. Any operation described herein as occurring at or performed by a particular component, can be implemented in such a manner that one component-specific function causes an operation to occur or be performed at another component, e.g., at a local or remote system.

An embodiment may provide in a power supply system a method of actively venting a cell comprising measuring one or more venting parameters of the cell, computing, using the one or more venting parameters, a pre-venting state of the cell, and triggering, responsive to computing that the pre-venting state has reached a threshold pre-venting state, an opening of the vent of the cell to release vent-gas. The triggering may be performed by activating a cell vent opening device to puncture or open a membrane of the vent. At least a portion of the cell vent opening device may disposed opposite the vent or operated to be disposed opposite the vent to enable the puncturing.

Another embodiment may provide a cell vent opening device that is selected from the list consisting of: a piezo electric actuator, a pyro trigger, an etched resistor, a needle, a heat applying device, and an electro-mechanical device.

Further, a plurality of cells may be provided and configured to enable active venting in a battery pack, the active venting being controlled by a computer system such as a battery management system (BMS).

The illustrative embodiments are further described with respect to processes achieved using certain types of data, functions, equations, configurations, locations of embodiments, additional data, devices, data processing systems, environments, components, and applications only as examples. Any specific manifestations of these and other similar artifacts are not intended to be limiting to the disclosure. Any suitable manifestation of these and other similar artifacts can be selected within the scope of the illustrative embodiments.

The illustrative embodiments are described using specific communications, code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable devices, structures, systems, applications, or architectures therefor, may be used in conjunction with such embodiment of the disclosure within the scope of the disclosure. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

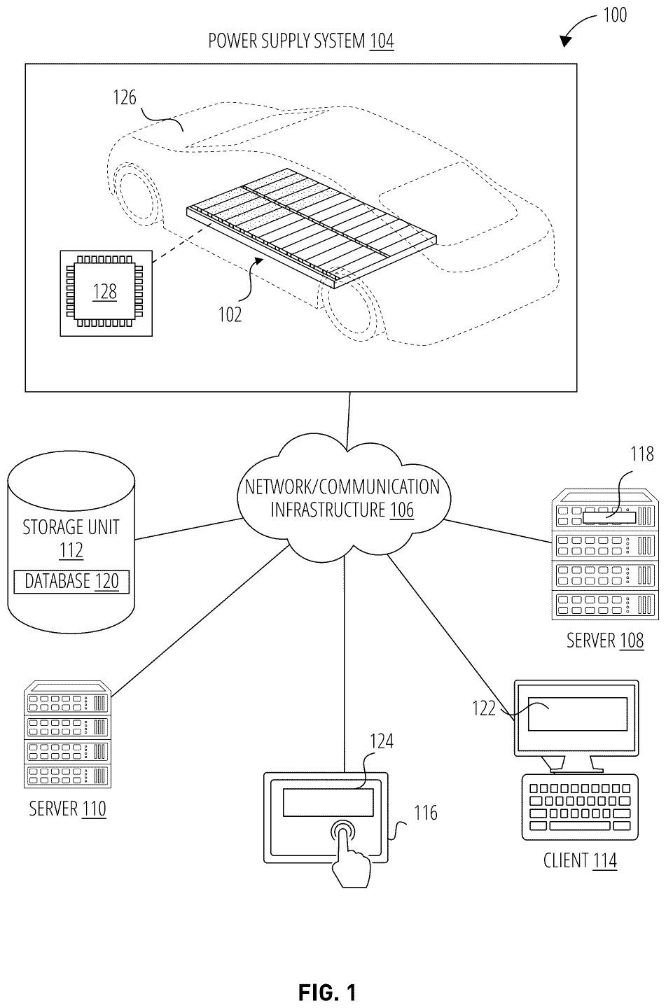

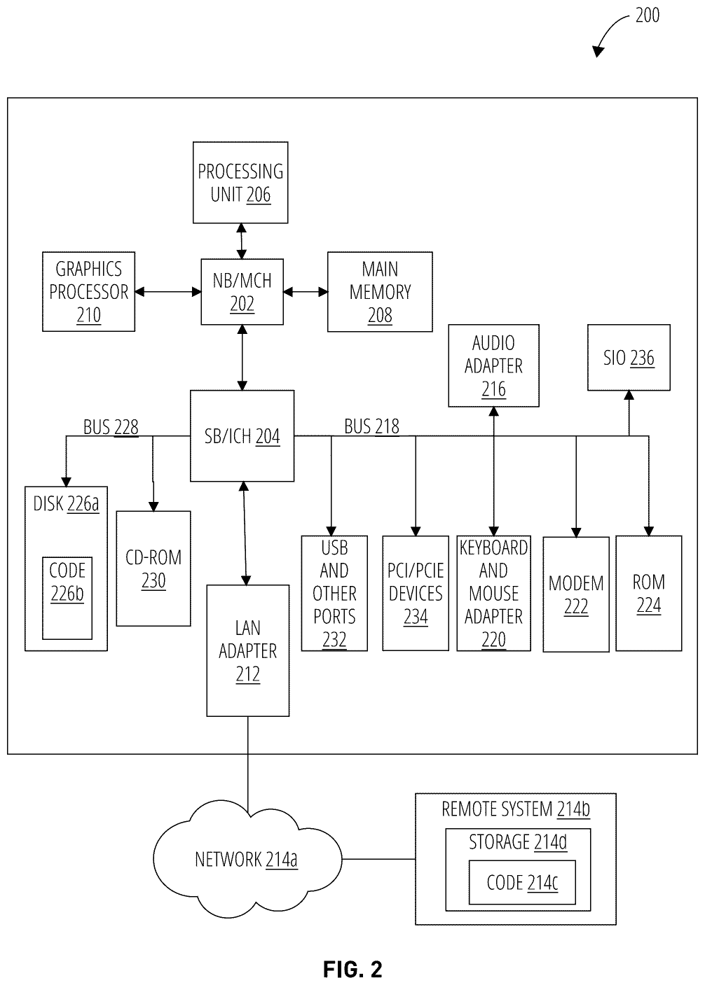

With reference to the figures and in particular with reference to FIG. 1 and FIG. 2, these figures are example diagrams of data processing environments and systems in which illustrative embodiments may be implemented. FIG. 1 and FIG. 2 are only examples and are not intended to assert or imply any limitation with regard to the environments in which different embodiments may be implemented. A particular implementation may make many modifications to the depicted environments based on the following description.

FIG. 1 depicts a block diagram of a power supply environment 100 in which illustrative embodiments may be implemented. Power supply environment 100 includes a network/communication infrastructure 106. Network/communication infrastructure 106 is the medium used to provide communications links between various devices, databases and computers connected together within power supply environment 100. Network/communication infrastructure 106 may include connections, such as Controller Area Network (CAN) Bus connections, Programmable Logic Controllers (PLC), wires, wireless communication links, etc. The environment includes a power supply system 104 and clients or servers configured to perform one or more processes. The power supply system 104 may include a battery pack 102 which may comprise one or more modules and one or more cells. In some cases, the battery pack 102 may reside in an electric vehicle 126 and the battery pack may comprise a traction battery including one or more traction modules and a secondary/hybrid battery including one or more hybrid modules. A dashboard 116 and a dashboard application 124 may be part of or separate from the power supply system 104. The dashboard application 124 may be operable to control parameters of the power supply system 104 including, for example, which batteries are in operation. It will become apparent to a person skilled in the relevant art(s) that the concepts described herein are directed to power supply systems that may be in other electrified/electric vehicles, including, but not limited to, battery electric vehicles (BEV's), plug-in hybrid electric vehicles, motor vehicles, railed vehicles, watercraft, and aircraft configured to utilize rechargeable electric batteries as their main source of energy to power their drive systems propulsion or that possess an all-electric drivetrain. Concepts described herein may also be applicable in any other electric/electrified systems that may store energy for use by a high voltage load.

The active venting engine 128 may a part of the power supply system 104 or may be separate from the power supply system 104 and may be configured to perform the active venting methods described herein including obtaining venting parameters and computing venting thresholds for one or all of the cells of the battery pack 102.

Clients or servers are only example roles of certain data processing systems connected to network/communication infrastructure 106 and are not intended to exclude other configurations or roles for these data processing systems or to imply a limitation to a client-server architecture. Server 108 and server 110 couple to network/communication infrastructure 106 along with storage unit 112. Software applications, such as embedded software applications may execute on any computer or processor or controller in power supply environment 100. Client 114, dashboard 116 may also be coupled to network/communication infrastructure 106. Client 114 may be a remote computer with a display. A data processing system, such as server 108 or server 110, or clients (client 114, dashboard 116) may contain data and may have software applications or software tools executing thereon.

As another example, an embodiment can be distributed across several data processing systems and a data network as shown, whereas another embodiment can be implemented on a single data processing system within the scope of the illustrative embodiments. Data processing systems (server 108, server 110, client 114, dashboard 116) also represent example nodes in a cluster, partitions, and other configurations suitable for implementing an embodiment.

Client application 122, dashboard application 124, or any other application such as server application 118 may implement an embodiment described herein. Any of the applications can use data from power supply system 104 and to partially or fully perform one or more processes described herein. The applications can also obtain data from storage unit 112 for power supply and preemptive thermal management purposes. The applications can also execute in any of data processing systems (server 108 or server 110, client 114, dashboard 116).

Server 108, server 110, storage unit 112, client 114, dashboard 116, may couple to network/communication infrastructure 106 using wired connections, wireless communication protocols, or other suitable data connectivity. Client 114, and dashboard 116 may be, for example, mobile phones, personal computers, or network computers.

In the depicted example, server 108 may provide data, such as boot files, operating system images, and applications to client 114, and dashboard 116. Client 114, and dashboard 116 may be clients to server 108 in this example. Client 114, and dashboard 116 or some combination thereof, may include their own data, boot files, operating system images, and applications. Power supply environment 100 may include additional servers, controllers, clients, and other devices that are not shown. FIG. 1 is intended as an example, and not as an architectural limitation for the different illustrative embodiments.

With reference to FIG. 2, this figure depicts a block diagram of a data processing system in which illustrative embodiments may be implemented. Data processing system 200 is an example of a computer, such as client 114, dashboard 116, server 108, or server 110 in FIG. 1, or another type of device in which computer usable program code, embedded code or instructions implementing the processes may be located for the illustrative embodiments.

Data processing system 200 is described as a computer only as an example, without being limited thereto. Implementations in the form of other devices may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to North Bridge and memory controller hub (NB/MCH) 202 through an accelerated graphics port (AGP) in certain implementations.

In the depicted example, local area network (LAN) adapter 212 is coupled to South Bridge and input/output (I/O) controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and input/output (I/O) controller hub (SB/ICH) 204 through bus 218. Hard disk drive (HDD) or solid-state drive (SSD) 226a and CD-ROM 230 are coupled to South Bridge and input/output (I/O) controller hub (SB/ICH) 204 through bus 228. PCI/PCIe devices 234 may include, for example, Ethernet adapters, add-in cards, and PC cards for notebook computers. PCI uses a card bus controller, while PCIe does not. Read only memory (ROM) 224 may be, for example, a flash binary input/output system (BIOS). Hard disk drive (HDD) or solid-state drive (SSD) 226a and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and input/output (I/O) controller hub (SB/ICH) 204 through bus 218.

Memories, such as main memory 208, read only memory (ROM) 224, or flash memory (not shown), are some examples of computer usable storage devices. Hard disk drive (HDD) or solid-state drive (SSD) 226a, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices.

Instructions for the operating system, and applications or programs, (such as server application 118, or client application 122 or dashboard application 124) are located on storage devices, such as in the form of codes 226b on Hard disk drive (HDD) or solid-state drive (SSD) 226a, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory (ROM) 224, or in one or more peripheral devices.

Furthermore, in one case, code 226b may be downloaded over network 214a from remote system 214b, where similar code 214c is stored on a storage device 214d in another case, code 226b may be downloaded over network 214a to remote system 214b, where downloaded code 214c is stored on a storage device 214d.

The hardware in FIG. 2 may vary depending on the implementation. Other internal hardware or peripheral devices, such as flash memory, equivalent non-volatile memory, or optical disk drives and the like, may be used in addition to or in place of the hardware depicted in FIG. 2. In addition, the processes of the illustrative embodiments may be applied to a multiprocessor data processing system.

A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub (NB/MCH) 202. A processing unit may include one or more processors or CPUs.

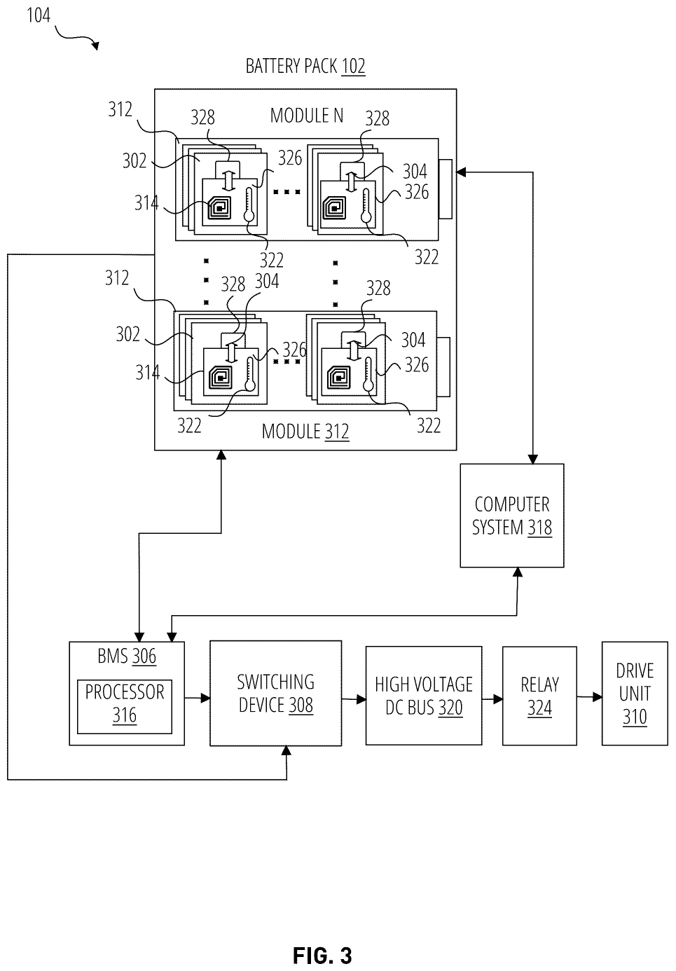

Turing to FIG. 3, a power supply system 104 is shown. The power supply system 104 may include a battery having high power chemistries and/or high range chemistries. The power supply system 104 may comprise a battery pack 102, one or more modules 312, a plurality of cells 302 which may be housed in the modules 312 or directly in a battery pack housing, vents 328, cell vent opening devices 304 and a BMS 306. Each cell may comprise one or more sensors 314 such as voltage sensors, pressure sensors or temperature sensors 322 configured to measure a state of the individual cell. The sensors 314 may be disposed directly on a housing of the cell or on a control board 326 which may receive and/or send active vent control data from and/or to the BMS 306 respectively. The sensors 314 may include or be separate from the temperature sensors 322. The sensors 314 may measure the voltage, current, temperature, SOC (State of Charge), SOH (State of Health), or other state of corresponding cells. A module may house a plurality of cells and in some embodiments such as in a hybrid architecture comprising traction batteries and range-extender batteries, the module may further comprise bi-directional a DC-DC converter to allow isolation and current to be managed and to throttle the contribution of the module, both absorbing and providing energy to a main bus/high voltage dc bus 320 of the power supply system 104.

The cell vent opening device 304 may be configured to open the vent 328 of a corresponding cell 302 based on instructions received from a controller, the instructions being determined by a computation or prediction of an impending failure event as described herein. The vent 328 may be a design weak point on a cell cap assembly or on another side of the cell and may be punctured to allow for a controlled release of internal pressure.

The BMS 306 may be configured to communicate with the control board 326 of each cell 302. In case a cell is determined to be approaching a failure event, the BMS may send mitigation instructions thereto. One or more processors (processor 316, or a processor of computer system 318) may be used in a number of configurations to enable the performance of one or more processes or operations described herein. The power supply system 104 may also comprise a switching device 308 which may be controlled to operatively couple a drive unit 310 or load of the vehicle to power from the power supply system 104 through a relay 324. The switching device 308 may comprise relays or contactors configured to couple power from the battery to the load or drive unit 310. The switching device 308 may also comprise a controller or may receive instructions from another controller such as the BMS 306 that controls and switches on a preset operational mode according to predetermined criteria.

In an illustrative embodiment, charge and discharge pulses may be generated for the cells 302 for a cell health measurement procedure. For example, by controlling the current for a cell of the module 312 measuring the voltages of each of the cells 302, the impedances of said each of the cells 302 are computable and comparable to reference data, in order to identify any unwanted deviations in a cell impedance and a corresponding change in the health of the cell.

The BMS may monitor and control the performance of the battery pack 102. The BMS 306 may monitor several pack level and cell level characteristics such as cell current, cell voltage obtained through the control board 326. The BMS 306 may have non-volatile memory such that data may be retained when the BMS 306 is in an off condition. Retained data may be available upon the next key cycle. The sensors 314 or control board 326 may transfer signals in analog or digital form to the BMS 306. In some embodiments, the sensor functionality may be incorporated internally to the BMS 306. That is, the sensor hardware may be integrated as part of the circuitry in the BMS 306 and the BMS 306 may handle the processing of raw signals.

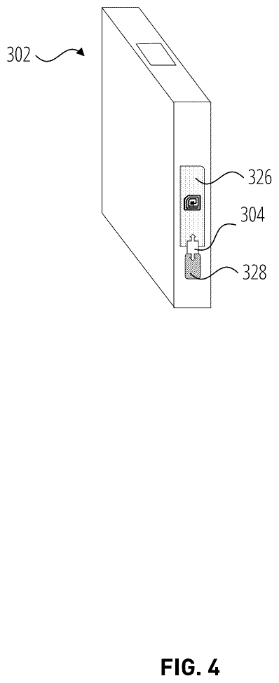

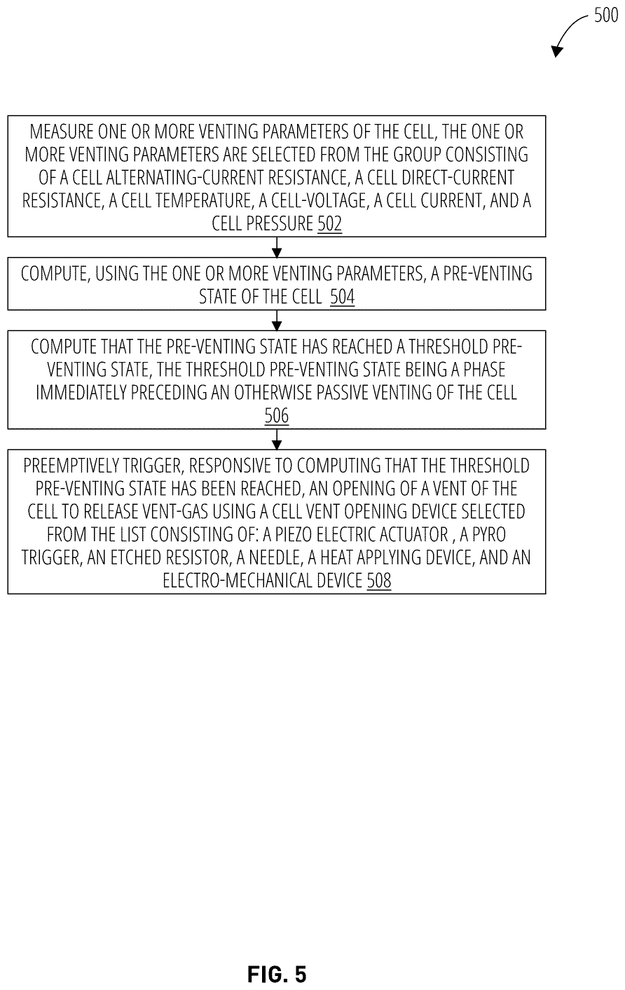

FIG. 4 illustrates a perspective view of a cell 302 according to an illustrative embodiment. The cell 302 comprises a cell vent opening device 304, a control board 326, and a vent 328. The vent is shown in FIG. 4 on a side of the cell not containing the cap assembly but may alternatively be on a side of the cell containing the cap assembly. The vent 328 may allow for the release of excess gas or pressure that may build up inside the cell during operation or in case of abnormal conditions. The vent 328 may comprise, for example, a thin, flexible material that may be ruptured or opened actively/preemptively upon application of an end of the cell vent opening device 304, allowing the gas to escape. The vent material may be chosen for its ability to withstand normal operating conditions but rupture when the external force, exceeding a threshold is applied. The method of actively venting the cell is described in FIG. 5 and comprises measuring one or more venting parameters of the cell, the one or more venting parameters being selected from the group consisting of a cell alternating-current resistance, a cell direct-current resistance, a cell temperature, a cell-voltage, a cell current, a cell gas pressure, a cell gas concentration, a cell chemistry, and ambient temperature; computing, using the one or more venting parameters, a pre-venting state of the cell; computing that the pre-venting state has reached a threshold pre-venting state, the threshold pre-venting state being a phase immediately preceding an otherwise passive venting of the cell; and preemptively triggering, responsive to computing that the threshold pre-venting state has been reached, an opening or puncturing of a vent of the cell to release vent-gas. In an aspect, the one or more venting parameters may be chosen based on the inherent ability of the parameter to change during the life cycle of the cell, which contributes directly or indirectly to venting. For example, cell geometry may stay constant during the life cycle of a cell and thus may provide little to no use as a venting parameter whereas a cell temperature or cell voltage may change a many times during the life cycle and thus may contribute to venting. The opening or puncturing may be performed with a cell vent opening device selected from the list consisting of: a piezo electric actuator, a pyro trigger, an etched resistor, a needle, a heat applying device, and an electro-mechanical device.

More specifically, FIG. 5 describes an active venting method which may be performed using the active venting engine 128. The active venting engine 128 may be, for example, a BMS 306 and/or other controller or computer system in communication with the cell vent opening device. The active venting engine 128 may be configured to operate to reduce the specific energy of material released during a cell failure and may also prevent the complete failure of the cell upon predicting an impending failure.

In block 502, the active venting engine 128 may measure, or receive through the sensor 314, one or more venting parameters of the cell 302.

In block 504, the active venting engine 128 may compute, using the one or more venting parameters, a pre-venting state of the cell and may compute in block 506, that the pre-venting state has reached a threshold pre-venting state, the threshold pre-venting state being a phase immediately preceding an otherwise passive venting of the cell. More specifically, the amount of gas generated in cell 302 is a byproduct of electrochemical and chemical reactions inside the cell, which may occur when the cell is operational or in storage. The gas generation rate may be dependent on chemistry, manufacturing quality, and battery management. Gas generation may be also affected by ambient temperature, discharge current, and by overcharging and over-discharging. By measuring cell attributes which are affected by operation of the cell, and thus give a direct or indirect indication of vent-gas pressure, along with other gas generation parameters such as chemistry and ambient temperature, i.e., collectively referred to herein as venting parameters, one or more states of the vent-gas may be obtained and evaluated for impending cell failure predictions. In an example, when conditions are detected where a vent is inevitable, actively triggering the vent may allow for a lower European Council for Automotive Research and Development (EUCAR) level since cell electrolyte may be directed to exit the cell prior to significant temperature or pressure build up.

The amount of gas a cell vents leading up to cell failure may be dependent on chemistry and may comprise, for example, an initial phase wherein the amount of emitted gas may be qualified as minuscule, a secondary phase wherein the amount of emitted gas may be qualified as relatively moderate (relative to a minuscule amount) and may for example be accompanied by visible vapor, and a tertiary phase wherein the amount of emitted gas may be qualified as excessive and may be accompanied by gaseous reactions involving volatile gases such as hydrocarbons which may generate additional heat resulting in propagation of thermal failure thermal runaway, battery cell failure, and fire. When the temperature of a cell reaches an onset temperature for thermal runaway, (for example, around 160° C. for LIB cells), exothermic reactions such as SEI layer decomposition, reduction of metal-oxide electrode material, and electrolyte decomposition may occur. The phases may be accompanied by specific changes in venting parameters that may be measurable by the sensors 314 or by the active venting engine 128. Moreover, gas sensors such as piezoelectric gas sensors, photoionization detectors, infrared point sensors, ultrasonic sensors, electrochemical gas sensors, and metal-oxide-semiconductor (MOS) sensors may be incorporated in the cell design and operable to measure the concentration of gases released as a venting parameter. Of course, the phases are not limited to the three given and other phases may be possible.

Based on the venting parameters, a threshold pre-venting state may be computed to determine a time in which preemptive venting may be triggered. The computation may be based on a machine learning engine, combinatorial analysis and/or detection of threshold values of the venting parameters.

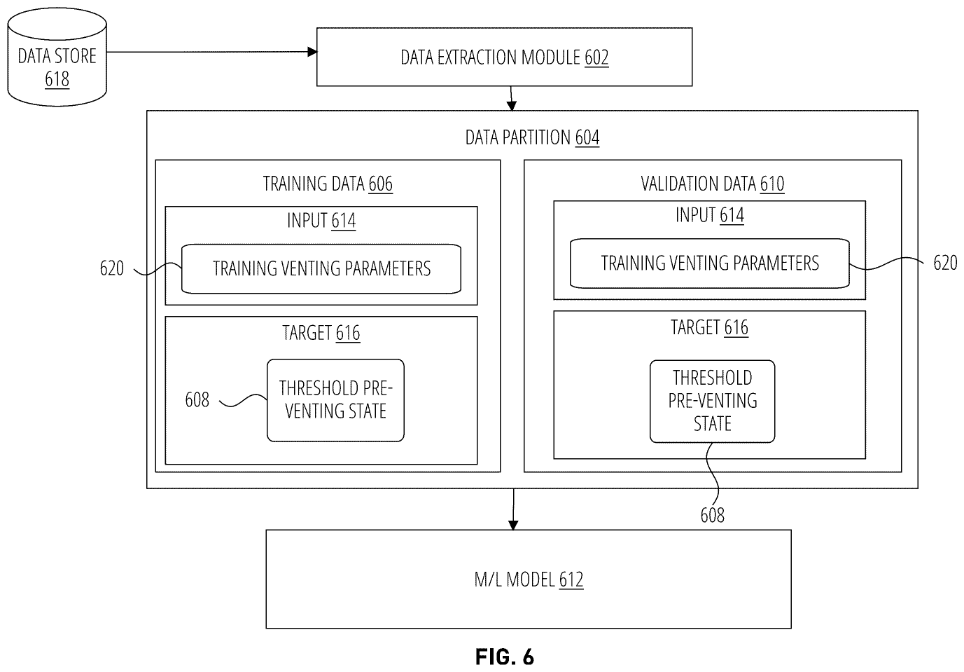

With regards to machine learning, a decision that a threshold pre-venting state has been reached may be computed using an active venting proposal module and one or more venting parameters as input to the active venting proposal module, wherein the active venting proposal module is a machine learning model. The machine learning model may be trained based on a training, validation and testing dataset of input venting parameters and output threshold pre-venting states. In some embodiments, the output threshold pre-venting state may be a binary value. FIG. 6 shows a block diagram illustrating a training of a machine learning model for active venting of a cell. The training may be performed by a machine learning engine which may extract, by data extraction module 602, a plurality of training venting parameters 620 from the dataset of data store 618 for use in training the m/l model 612. The plurality of training venting parameters 620 may be preprocessed sensor data preprocessed to reduce dimensionality thereof or may be raw sensor data which may be processed by a feature processing/selection algorithm to produce a combination of input venting parameters from, for example, cell alternating-current resistance, cell direct-current resistance, cell temperature, cell-voltage, cell current, cell gas pressure, cell gas concentration, cell chemistry, ambient temperature, and impedance spectra as well as derivatives thereof obtained from electrochemical impedance spectroscopy (EIS) tests. The dataset of input venting parameters used for training may be obtained by recording actual venting parameters and corresponding venting states/phases from actual controlled cell operation events including variation of cell parameters till failure. However, in some embodiments, venting parameters and corresponding venting states/phases may alternatively or in addition be obtained from simulation models simulating gaseous states of emitted gases and/or simulation models based on characterization experiments and parameter estimation. Generally, training may take longer with larger ranges on parameters, more parameters, and larger data sets, and this may lead to a robust algorithm.

For each set of training venting parameters 620 of the plurality of training venting parameters, the set may be provided as input to the m/l model 612 which may be a deep neural network, and which may propose, a corresponding threshold pre-venting state 608 such as a threshold pre-venting state decision. A difference or accuracy of the proposed threshold pre-venting state relative to the corresponding target threshold pre-venting state (target 616) may be measured for use in updating parameters of the m/l model 612. The proposal may be repeated with the updated parameters using other training input and corresponding training targets until the measured differences are minimized or the accuracy of predictions optimized. This method may be especially robust and beneficial for scenarios in which the emitted gas may have several different phases or states (e.g., five, seven, twenty phases etc.) that may vary from one cell chemistry to another, and thus have corresponding venting parameters values or ranges that may be cell chemistry dependent. As such, the machine learning model may be trained to accurately predict the threshold pre-venting state of a cell devoid of limitations posed by constantly-changing chemistries of battery cells in the industry. In an aspect herein, a training input dataset may include at least an indication of the cell chemistry. In another aspect herein, a training input dataset may include at least an indication of an alternating current resistance and/or a direct current resistance of the cell.

More generally, data extraction module 602 of FIG. 6 may extract data from data store 618 and partition the data into training data 606 and validation data 610. One or more of the training venting parameters 620 may be used as at least part of the input 614 (training or validation inputs) and one or more of the threshold pre-venting states 608 may be used as targets 616 (training or validation targets). Training data may be used to train the model, while validation data may be used to tune the machine learning model's hyperparameters and make decisions about the model's structure, such as selecting between different architectures. Further, test data may be used to evaluate the final performance of the machine learning model and to estimate its generalization ability to new, unseen data. The trained machine learning model (active venting proposal module) may then be used to predict that a threshold pre-venting state of a new cell has been reached and the prediction decision may be used to activate the cell vent opening device 304. Thus, a supervised machine learning model of any architecture that is sufficiently data-hungry to require not just more training data for a particular cell type but also for diverse cell types actively venting the diverse cell types than is practical and affordable to obtain using basic and passive techniques can be developed and well maintained at more manageable, more effective, and safer rates.

In an aspect herein, the threshold pre-venting state may be computed based on combinatorial analysis or hard thresholds of venting parameters. For example, upon sensing that temperature is increasing and voltage (and/or cell alternating current resistance and/or direct current resistance) is going down, the active venting engine 128 may determine a cell short failure event. Further, depending on the failure event, such as dendritic growth or a hard short, pressure buildup in the cell above a normal value may take a period of time to occurrence of the failure event (e.g., 30-60 seconds). For another failure event such as a soft short, pressure buildup period may last for several minutes or hours. By detecting the pressure build-up based on combinatorial analysis or the usage of hard threshold values of venting parameters, the active venting engine 128 may operate the cell vent opening device 304 to open or puncture the vent 328 sooner than the failure event can occur. Further threshold values that may be utilized for active venting include cell voltages over 6V or temperatures over 150C for a lithium iron phosphate (LFP) cell, as well as cell voltages over 5V or temperatures over 130C for a nickel manganese cobalt (NCM) cell. Moreover, pressure increases may be a result of routine operations of the cell. By discriminating between pressure increases caused by routing operations and by non-routing operations, the active venting engine 128 may more accurately determine impending failure events and operate the cell vent opening device 304 to actively vent the cell and prevent the failure event for proper inspection or to reduce the severity of an inevitable failure event that was inevitable at that point. In some embodiments herein, measurements of internal gas pressure of the cells may be unavailable as venting parameters. Thus, the pressure may be alternatively monitored through analysis of other available venting parameters. In general, combinatorial and threshold values may be defined from data obtained from design of experiment (DOE) tests, including for example, cell voltage, cell temperature, cell alternating-current resistance, cell direct-current resistance, and impedance spectra as well as derivatives of the impedance spectra. One example design, for illustration, comprises computing an orthogonal array of cells at various temperatures from 40C to 180C held at voltages between 4V and 7V for times ranging from 10 seconds to 2 hours. Of course, this is not meant to be limiting as other designs may be obtained in view of the descriptions herein.

Turning back to FIG. 5, the active venting engine 128 may preemptively trigger using the cell vent opening device 304, in block 508, an opening of a vent of the cell to release vent-gas responsive to computing that the threshold pre-venting state has been reached. In an aspect herein, the cell vent opening device may be selected from the list consisting of: a piezo electric actuator, a pyro trigger, an etched resistor, a needle, a heat applying device, and an electro-mechanical device. The cell vent opening device may be disposed on the control board 326 or in close proximity to the vent. The piezo electric actuator may apply a displacement to a needle of sharp device configured to pierce the vent 328 and may be operable to pierce the membrane of the vent in an active venting action. A pyro trigger may alternatively be operated to explode to actively open the vent 328. A resistor may also be etched onto the vent or onto the control board and may be operable by input current to heat up and rupture the vent. An electromechanical device such a solenoid which converts electrical energy into mechanical energy may be used to puncture the vent with a moving magnetic rod.

In another aspect, the battery pack 102 a plurality of cells 302 of a same or different chemistries and each cell of the plurality of cells may be actively controlled by one or more active venting engines 128 to preemptively open the vent 328 of said each cell to release vent material.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Aspects of the present disclosure are described herein concerning flowchart illustrations and/or block diagrams of methods, apparatus (systems), and computer program products according to embodiments of the disclosure. It will be understood that computer readable program instructions can implement each block of the flowchart illustrations and/or block diagrams and combinations of blocks in the flowchart illustrations and/or block diagrams.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other devices to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of actively venting a cell comprising:
measuring one or more venting parameters of the cell;
determining, using the one or more venting parameters, a pre-venting state of the cell; and
responsive to a determination that the pre-venting state has reached a threshold pre-venting state, preemptively triggering an opening of a vent of the cell to release vent-gas by activating a cell vent opening device to open the vent, at least a portion of the cell vent opening device being disposed in close proximity to the vent.

2. The method of claim 1, wherein the opening comprises puncturing a hole in the vent.

3. The method of claim 1, wherein:
the threshold pre-venting state is a phase immediately preceding an otherwise passive venting of the cell, and
the preemptively triggering is performed prior to the otherwise passive venting of the cell to preclude the otherwise passive venting of the cell.

4. The method of claim 1, wherein the one or more venting parameters are selected from the group consisting of a cell alternating-current resistance, a cell direct-current resistance, a cell temperature, a cell-voltage, a cell current, a cell gas pressure, a cell gas concentration, a cell chemistry, and ambient temperature.

5. The method of claim 4, further comprising:
proposing, using an active venting proposal module, and the one or more venting parameters as input to the active venting proposal module, a decision about the threshold pre-venting state being reached, and
preemptively triggering the opening based on the decision,
wherein the active venting proposal module is a trained machine learning model.

6. The method of claim 4, further comprising computing that the pre-venting state has reached a threshold pre-venting state based on computing that the one or more venting parameters has reached a threshold value.

7. The method of claim 4, further comprising computing that the pre-venting state has reached a threshold pre-venting state based on combinatorial analysis of the one or more venting parameters.

8. The method of claim 4, further comprising computing the pre-venting state independent of the chemistry of the cell.

9. The method of claim 4, further comprising:
selecting the cell vent opening device from the list consisting of: a piezo electric actuator, a pyro trigger, an etched resistor, a needle, a heat applying device, and an electro-mechanical device.

10. A non-transitory computer-readable medium storing instructions that when executed by a computer, cause the computer to:
measure one or more venting parameters of the cell;
compute, using the one or more venting parameters, a pre-venting state of the cell; and
preemptively trigger, responsive to computing that the pre-venting state has reached a threshold pre-venting state, an opening of a vent of the cell to release vent-gas;
wherein the preemptively triggering is performed by activating a cell vent opening device to open the vent, at least a portion of the cell vent opening device being disposed in close proximity to the vent.

11. The non-transitory computer-readable medium of claim 10, wherein the one or more venting parameters are selected from the group consisting of a cell alternating-current resistance, a cell direct-current resistance, a cell temperature, a cell-voltage, a cell current, a cell gas pressure, a cell gas concentration, a cell chemistry, and ambient temperature.

12. A system comprising:
a cell;
a cell vent opening device;
a processor; and
a memory storing instructions that, when executed by the processor, configure the system to:
measure one or more venting parameters of the cell;
compute, using the one or more venting parameters, a pre-venting state of the cell; and
preemptively trigger, responsive to computing that the pre-venting state has reached a threshold pre-venting state, an opening of a vent of the cell to release vent-gas;
wherein the preemptively triggering is performed by activating the cell vent opening device to open the vent, at least a portion of the cell vent opening device is disposed in close proximity to the vent.

13. The system of claim 12, wherein the cell vent opening device is selected from the list consisting of: a piezo electric actuator, a pyro trigger, an etched resistor, a needle, a heat applying device, and an electro-mechanical device.

14. The system of claim 13, wherein the one or more venting parameters are selected from the group consisting of a cell alternating-current resistance, a cell direct-current resistance, a cell temperature, a cell-voltage, a cell current, a cell gas pressure, a cell gas concentration, a cell chemistry, and ambient temperature.

15. The system of claim 14, wherein the instructions further configure the system to:
propose, using an active venting proposal module, and the one or more venting parameters as input to the active venting proposal module, a decision about the threshold pre-venting state being reached, and
preemptively trigger the opening based on the decision,
wherein the active venting proposal module is a trained machine learning model.

16. The system of claim 14, wherein the instructions further configure the system to:
compute that the pre-venting state has reached a threshold pre-venting state based on computing that the one or more venting parameters has reached a threshold value.

17. The system of claim 14, wherein the instructions further configure the system to:
compute that the pre-venting state has reached a threshold pre-venting state based on combinatorial analysis of the one or more venting parameters.

18. The system of claim 13, wherein the cell vent opening device is disposed opposite to the vent.

19. The system of claim 12, wherein the cell vent opening device is disposed on a control board or housing of the cell.

20. The system of claim 12, further comprising a plurality of other cells, each other cell of the plurality of other cells comprising a corresponding cell vent opening device configured for preemptively triggering, based on received instructions that a corresponding pre-venting state of the other cell has reached a corresponding threshold pre-venting state, the opening of the vent of the other cell to release vent-gas.
